(19) United States
(12) Patent Application Publication
(10) Pub. No.: US 2010/0265430 A1
(43) Pub. Date: Oct. 21, 2010

(54) DISPLAY DEVICE WITH CONDUCTIVE MASKING FILM FOR DISCHARGING STATIC ELECTRICITY

(75) Inventor: WEI XU, Shenzhen (CN)

Correspondence Address: Altis Law Group, Inc.;ATTN: Steven Reiss, 288 SOUTH MAYO AVENUE, CITY OF INDUSTRY, CA, 91789, US

(73) Assignees: INNOCOM TECHNOLOGY (SHENZHEN) CO., LTD., Shenzhen City (CN); CHIMEI INNOLUX CORPORATION, Miao-Li County (TW)

(21) Appl. No.: 12/762,381

(22) Filed: Apr. 19, 2010

(30) Foreign Application Priority Data
Apr. 17, 2009 (CN) 200910301648.1

(51) Int. Cl. G02F 1/1333

(52) U.S. Cl. 349/58

(57) ABSTRACT

A display device such as a liquid crystal display (LCD) includes a display panel having a display surface and a back surface parallel to the display surface, a backlight module provided below the display panel, and a masking film having an electrically conductive characteristic. The masking film is attached to a peripheral region of the back surface of the display panel, and includes a connecting portion directly contacting the grounding member, such as a grounding pad of a flexible printed circuit (FPC) board and a metal frame. The display device is capable of discharging static electricity.

### BACKGROUND

1. Technical Field

The present disclosure related to display devices, and more particularly to a liquid crystal display (LCD) which is configured to safely discharge static electricity from a display surface side of an LCD panel thereof.

2. Description of Related Art

Since LCDs have the advantages of portability, low power consumption, and low radiation, they have been widely used in various portable electronic products, such as notebook computers and personal digital assistants (PDAs). LCDs are also steadily replacing cathode ray tube (CRT) monitors commonly used with personal computers.

In general, an LCD is configured such that a backlight module, a display control circuit board, and the like are attached to an LCD panel, and then all these parts are accommodated in a frame. Friction between the LCD panel and the outside environment can generate much static electricity, which collects on surfaces of the LCD panel, particularly on peripheral regions of the surfaces. When the amount of collected static electricity is large, electrostatic discharge (ESD) may occur, and certain ESDs are liable to damage microcircuits inside the LCD panel. The result can seriously affect the performance and display quality of the LCD.

What is needed, therefore, is a display device, more particularly an LCD, that can overcome the above-described deficiencies.

### BRIEF DESCRIPTION OF THE DRAWINGS

The components in the drawings are not necessarily drawn to scale, the emphasis instead being placed upon clearly illustrating the principles of at least one embodiment. In the drawings, like reference numerals designate corresponding parts throughout the various views.

FIG. 1 is an exploded, isometric view of a first embodiment of a display device of the present disclosure.

FIG. 2 is an assembled view of the display device of FIG. 1.

FIG. 3 is an enlarged, abbreviated cross-section of the display device, taken along line III-III of FIG. 2.

FIG. 4 is an exploded, isometric view of a second embodiment of a display device of the present disclosure.

FIG. 5 is an enlarged, abbreviated cross-section of the display device of FIG. 4 after assembly.

FIG. 6 is an exploded, isometric view of a third embodiment of a display device of the present disclosure.

### DETAILED DESCRIPTION

Reference will now be made to the drawings to describe certain exemplary embodiments of the present disclosure in detail.

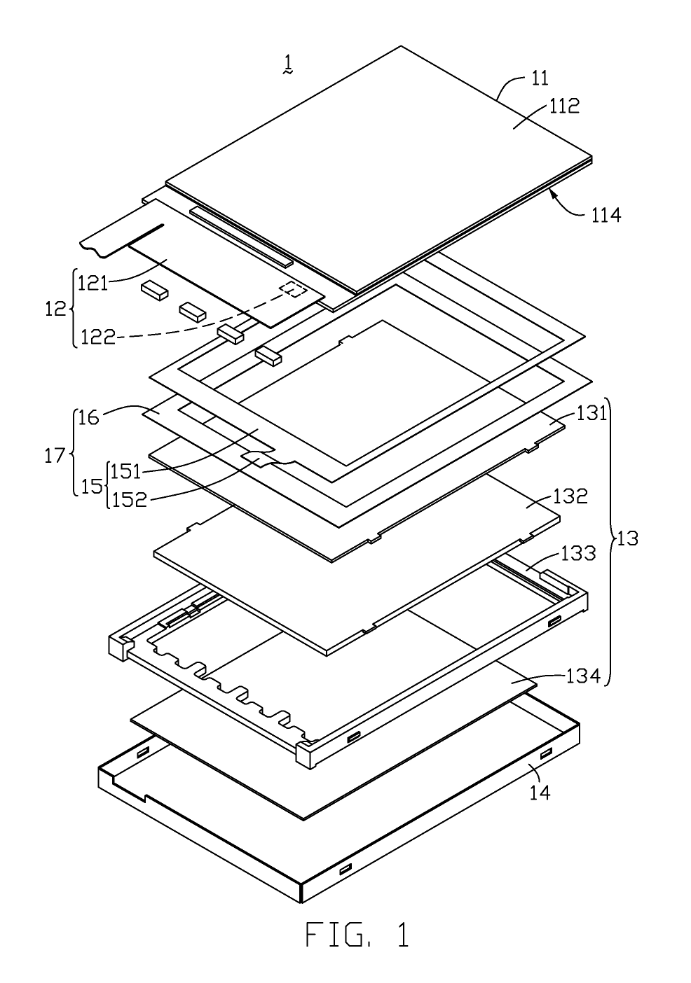

Referring to FIG. 1, a first embodiment of a display device of the present disclosure is shown. The display device may be an LCD, a light-emitting diode device, or other. The display device 1 includes a display panel 11, a masking film 17, a flexible printed circuit (FPC) board 12, a backlight module 13 and an outer frame 14. The display panel 11, the masking film 17 and the backlight module 13 are stacked in that order from top to bottom, and accommodated in the outer frame 14. One end of the FPC board 12 is mounted on one side of the display panel 11, and another end of the FPC board 12 is connected to an external circuit (not shown) in order to provide display signals to the display panel 11.

The display panel 11 includes a display surface 112 and a back surface 114 parallel to each other. The backlight module 13 generates uniform light beams, and the light beams enter the display panel 11 via the back surface 114.

The FPC board 12 includes a baseboard 121 and a grounding pad 122. The baseboard 121 is connected between the display panel 11 and the external circuit. The display signals, such as gray voltages, are transmitted to the display panel 11 via the baseboard 121. The grounding pad 122 is arranged on a surface of the baseboard 121 facing towards the backlight module 13, and is connected to ground via an earth wire in an electric plug (not shown) of the display panel 11.

The backlight module 13 includes at least one optical film 131 (only one is shown), a light guide plate 132, an inner frame 133, and a reflector 134. The at least one optical film 131 is located above the light guide plate 132. The inner frame 133 may be rectangular, and includes four sidewalls connected end-to-end to define a space accommodating the at least one optical film 131 and the light guide plate 132. The reflector 134 is provided under the light guide plate 132, and supported by the outer frame 14. The inner frame 133 can be, for example, plastic. Due to tolerance during assembly of the backlight module 13, a gap is defined between the inner frame 133 and the light guide plate 132. Therefore, a masking film 17 is required to prevent light from exiting through the gap.

The masking film 17 is a double-layer structure, including a conductive layer 15 stacked on a double-sided masking adhesive tape layer 16. The conductive layer 15 can, for example, be a transparent or opaque conductive material, and includes a main body 151 and a connecting portion 152. The main body 151 includes four strip sides (not labeled) connected end-to-end to form a rectangular frame shape. Thus the main body 151 can be attached to a peripheral region of the back surface 114 of the display panel 11. The connecting portion 152 extends outward from the main body 151, where the grounding pad 122 is located. The double-sided masking adhesive tape layer 16 has substantially the same shape as the main body 151. One side of the double-sided masking adhesive tape layer 16 is attached to the main body 151, thereby forming an integrated body with the conductive layer 15. The other side of the double-sided masking adhesive tape layer 16 is configured to attach to the at least one optical film 131, to avoid light leakage.

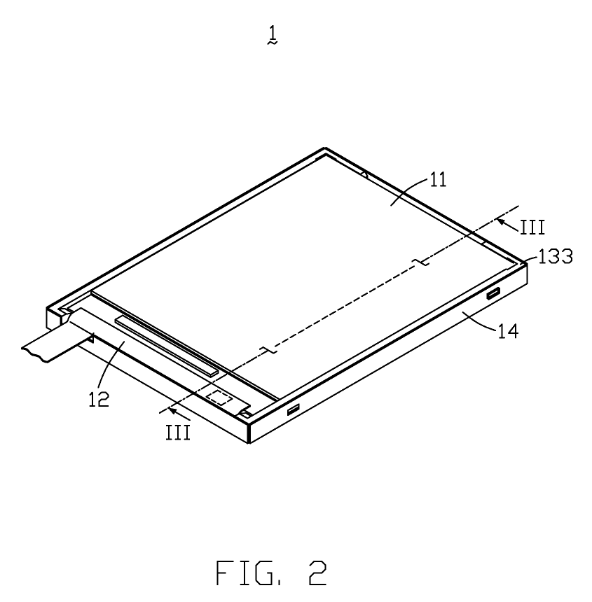

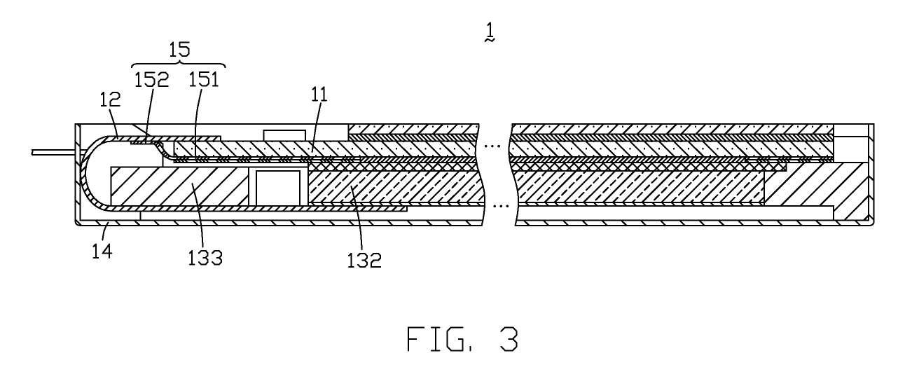

Referring also to FIG. 2 and FIG. 3, in assembly of the display device 1, the main body 151 of the conductive layer 15 is attached to the peripheral region of the back surface 114 of the display panel 11, and the connecting portion 152 of the conductive layer 15 is attached to the grounding pad 122 of the FPC board 12. The light guide plate 132 and the at least one optical film 131 are accommodated in the inner frame 133 in that order, and the reflector 134 is adhered to a bottom supporting plate of the outer frame 14. The combined masking film 17 and display panel 11 is adhered to a peripheral region of the at least one optical film 131, such peripheral region corresponding to the gap between the inner frame 133 and the light guide plate 131, with the adhesion being via the other side of the double-sided masking adhesive tape layer 16. The display panel 11, the backlight module 13 and the masking film 17 are accommodated in the outer frame 14 having the reflector 134.

Static electricity generated by friction may collect on the surfaces of the display panel 11. Such static electricity can be discharged to ground via the main body 151 of the conductive layer 15, the connecting portion 152 of the masking film 17, and the grounding pad 122 of the FPC board 12 in that order, thereby protecting the display panel 11 from damage by ESD. Thus one layer of the masking film 17, namely the conductive layer 15, provides the masking film 17 with an anti-ESD function. At the same time, the other layer of the masking film 17, namely the double-sided adhesive masking tape layer 16, provides adherence as between the peripheral region of the display panel 11 and the backlight module 13. That is, the double-sided adhesive masking tape layer 16 provides the masking film 17 with a light leakage prevention function to enhance the display quality of the display device 1. Thus, the one masking film 17 advantageously has dual functions.

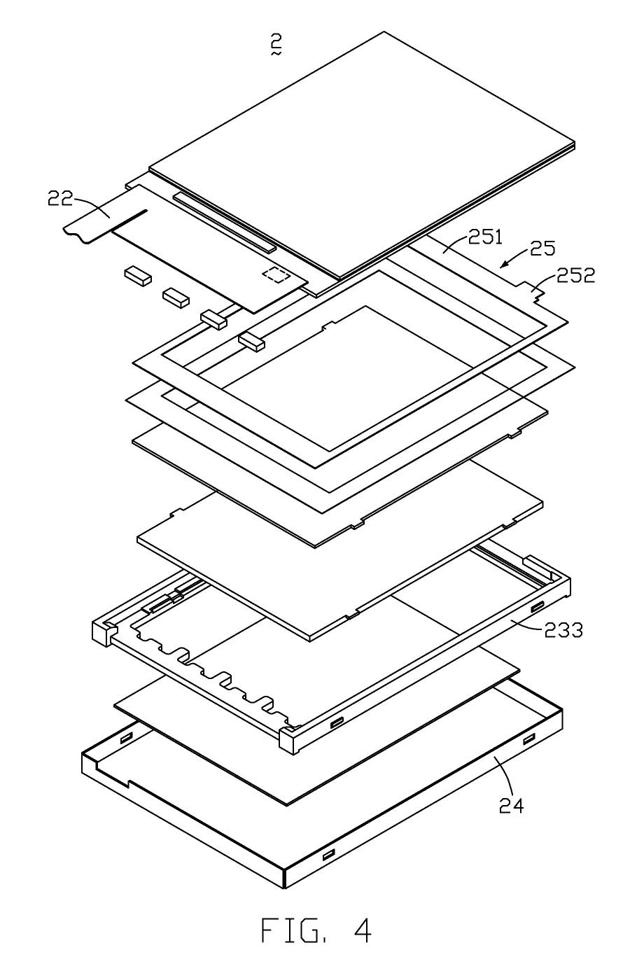

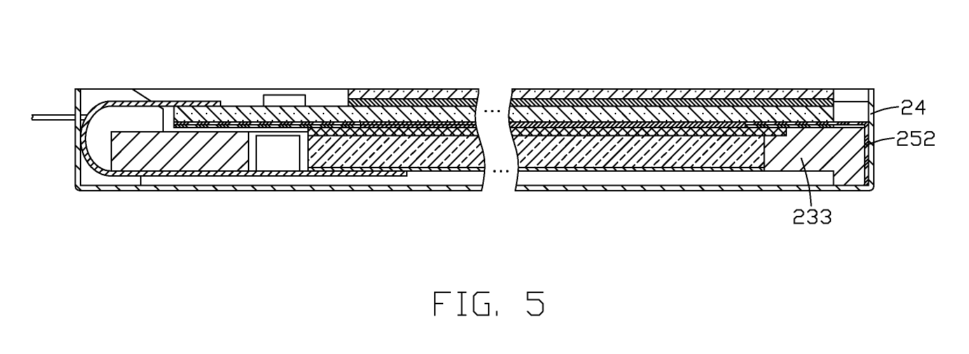

Referring to FIGS. 4 and 5, a second embodiment of a display device of the present disclosure is shown. The display device may be an LCD, a light-emitting diode device, or other. The display device 2 differs from the display device 1 of the first embodiment only in that a connecting portion 252 of a conductive layer 25 extends from one side of a main body 251 different from another side of the main body 251 corresponding to an FPC board 22. During assembly, the connecting portion 252 is folded along a corresponding side of an inner frame 233, so that the connecting portion 252 is attached to an inner surface of an outer frame 24. The outer frame 24 is made of metal, and is connected to ground by suitable means such as a grounding lead. Therefore, static electricity can be discharged to the outer metal frame 24 via the connecting portion 252.

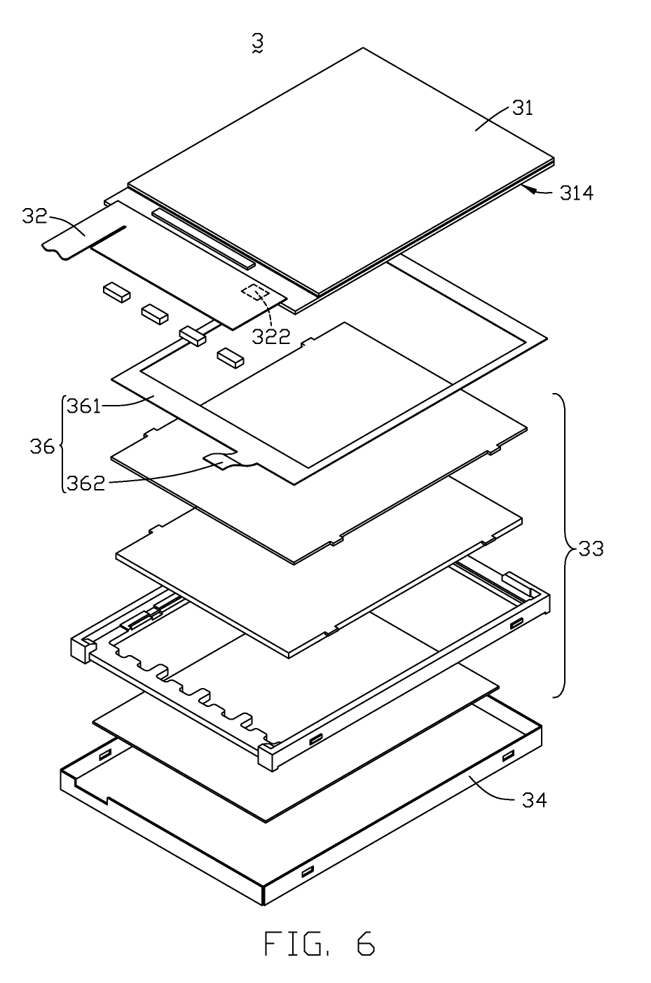

Referring to FIG. 6, a third embodiment of a display device 3 of the present disclosure is shown. The display device may be an LCD, a light-emitting diode device, or other. The display device 3 has a structure similar to the display device 1 of the first embodiment, differing only in that a masking film 36 of the display device 3 is a single layer structure made of an opaque electrically conductive material. In this embodiment, a main body 361 and a connecting portion 362 have the same structure as the main body 151 and the connecting portion 152 of the display device 1. Two surfaces of the main body 361 are attached to a peripheral region of a back surface 314 of a display panel 31, and a corresponding region of the backlight module 33, respectively. The connecting portion 362 is attached to a grounding pad 322 of an FPC board 32. Alternatively, the main body 361 and the connecting portion 362 can have the same structure as the main body 251 and the connecting portion 252 of the display device 2. In such case, the connecting portion 362 is attached to an inner surface of the outer frame 34. Thus for the display device 3, static electricity can be discharged either via the connecting portion 362 and the ground pad 322 (as illustrated in FIG. 6), or via the connecting portion 362 and the outer frame 34 (no illustration).

In the display device 3, the single-layer masking film 36 not only discharges static electricity, but also prevents light leakage. Unlike in the display device 1, no conductive layer is required for the masking film 36 of the display device 3. Therefore the display device 3 can have a reduced thickness and reduced cost.

It is to be understood, however, that even though numerous characteristics and advantages of the present embodiments have been set out in the foregoing description, together with details of the structures and functions of the embodiments, the disclosure is illustrative only; and that changes may be made in detail, especially in matters of shape, size and arrangement of parts within the principles of the disclosure to the full extent indicated by the broad general meaning of the terms in which the appended claims are expressed.

What is claimed is:

1. A liquid crystal display (LCD), comprising:
an LCD panel comprising a display surface and a back surface generally parallel to the display surface;
a backlight module provided below the LCD panel;
a flexible printed circuit (FPC) board connected to the display surface of the LCD panel for providing signals to the LCD panel, the FPC board comprising a grounding pad arranged on a surface thereof facing towards the backlight module; and
an electrically conductive masking film attached to a peripheral region of the back surface of the LCD panel, the masking film comprising a connecting portion contacting the grounding pad of the FPC board.

2. The LCD of claim 1, wherein the connecting portion is provided corresponding to a side of the LCD panel where the FPC board is connected.

3. The LCD of claim 2, wherein the masking film is a double-layer structure which comprises a conductive layer stacked on a double-sided masking adhesive tape layer.

4. The LCD of claim 3, wherein the connecting portion extends from the conductive layer.

5. The LCD of claim 4, wherein a main body of the conductive layer adheres to the peripheral region of the back surface of the LCD panel, and one side of the double-sided masking adhesive tape layer correspondingly adheres to the main body.

6. The LCD of claim 5, wherein the other side of the double-sided masking adhesive tape layer adheres to a surface of the backlight module facing towards the LCD panel.

7. The LCD of claim 6, wherein the backlight module comprises at least one optical film and a light guide plate arranged in that order from top to bottom, the at least one optical film and the light guide plate are accommodated in an inner frame, and a gap is defined between the light guide plate and the inner frame.

8. The LCD of claim 7, wherein the other side of the double-sided masking adhesive tape layer adheres to the at least one optical film and is located corresponding to the gap.

9. The LCD of claim 2, wherein the masking film is an opaque electrically conductive layer.

10. The LCD of claim 9, wherein the opaque electrically conductive layer is attached to the peripheral region of the back surface of the LCD panel by an adhesive.

11. The LCD of claim 10, wherein the backlight module comprises at least one optical film and a light guide plate arranged in that order from top to bottom, the at least one optical film and the light guide plate are accommodated in an inner frame, a gap is defined between the light guide plate and the inner frame, and the masking film contacts a corresponding region of a surface of the at least one optical film corresponding to the gap.

12. The LCD of claim 1, further comprising an outer frame accommodating the LCD panel, the backlight module, the FPC board and the masking film.

13. The LCD of claim 1, wherein the masking film is frame-shaped.

14. A liquid crystal display (LCD), comprising:
an LCD panel comprising a display surface and a back surface generally parallel to the display surface;
a backlight module provided below the LCD panel;
a masking film having an electrically conductive characteristic attached to a peripheral region of the back surface of the LCD panel, the masking film comprising a connecting portion; and
a metal frame accommodating the LCD panel, the backlight module, and the masking film, the connecting portion of the masking film contacting a part of the metal frame.

15. The LCD of claim 14, wherein the masking film is a double-layer structure which comprises a conductive layer stacked on a double-sided masking adhesive tape layer, and the connecting portion extends from the conductive layer.

16. The LCD of claim 15, wherein a main body of the conductive layer adheres to the peripheral region of the back surface of the LCD panel, and one side of the double-sided masking adhesive tape layer correspondingly adheres to the main body.

17. The LCD of claim 16, wherein the other side of the double-sided masking adhesive tape layer adheres to a surface of the backlight module facing towards the LCD panel.

18. The LCD of claim 14, wherein the masking film is an opaque electrically conductive layer.

19. The LCD of claim 14, further comprising an FPC board connected to one side of the LCD panel, wherein the connecting portion is located at another side of the LCD panel different from the side of the LCD panel where the FPC board is connected.

20. A display device, comprising:
a display panel;
a backlight module positioned for providing light beams to the display panel, the backlight module comprising a light guide plate and a frame accommodating the light guide plate, a gap defined between the light guide plate and a sidewall of the frame;
a masking film having an electrically conductive characteristic, the masking film located between the display panel and the backlight module, being attached to a peripheral region of the display panel for preventing leaking of light beams out from the gap, and contacting a grounding member of the display device for transmitting static electricity from the display panel to the grounding member.
